(19) United States
(12) Patent Application Publication
(10) Pub. No.: US 2008/0249640 A1
(43) Pub. Date: Oct. 9, 2008

(54) Method for Controlling a System Formed from Interdependent Units

(76) Inventors: Timothy Ramford Vittor, New South Wales (AU); Richard Adrian Willgoss, New South Wales (AU)

Correspondence Address: OSTROLENK FABER GERB & SOFFEN, 1180 AVENUE OF THE AMERICAS, NEW YORK, NY, 100368403, US

(21) Appl. No.: 10/581,411

(22) PCT Filed: Dec. 1, 2004
(86) PCT No.: PCT/AU04/01683

§ 371 Date: Aug. 7, 2006

(30) Foreign Application Priority Data
Dec. 1, 2003 (AU) 2003906638
Nov. 10, 2004 (AU) 2004906445

(51) Int. Cl. G05B 15/02; G05B 11/01; G05D 1/00

(52) U.S. Cl. 700/9; 700/19; 700/302

(57) ABSTRACT

A system formed from a plurality of interdependent units 200A to 200E are controlled to achieve an outcome by establishing a desired action for each unit responsive to the outcome but independently of the desired action of the other units. The control methodology has particular application for robotic manipulators.

### FIELD OF THE INVENTION

The present invention relates generally to systems formed from a plurality of interdependent units and more particularly to methods to control such systems to achieve an outcome, and control systems that implement that control methodology. The invention has been described, but is not exclusively directed to, a control methodology for a mechanical device such as a robot.

### BACKGROUND OF THE INVENTION

Robots, and in particular, a sub-class of robots which are termed “manipulators” in the art, have primarily been limited to hard automation applications (such as welding metal plates together on an assembly line) due to their task specific design. Traditional centralised control models rely on pre-programmed knowledge regarding the surrounding environment and the specific task requirements.

Due to the need for pre-programmed knowledge regarding the surrounding environment, robots engaged in complex movements are generally incapable of adapting to changing circumstances or of successfully completing tasks when faced with unfamiliar situations.

For this reason, robots have been limited to applications where the task to be performed requires repetition, precise movement and high speed. However, as the demand for automation has increased, there has been an increasing need to provide robots with increasingly sophisticated control mechanisms that allow the robotic device to perform successfully in dynamic and unpredictable situations.

Furthermore, robots which have many interdependent parts generally utilise complex algorithms in order to determine appropriate movement from one position to another. Complex algorithms are necessary because, in a robot with multiple interdependent units (i.e. a plurality of units that are constrained by each other in some manner, such as being physically linked or controlled) and multiple degrees of freedom, there are multiple possible solutions in moving from one point to another. That is, attempting to solve equations which determine how each unit should move, to move the robot to the desired position, result in multiple redundant solutions.

Therefore, complex algorithms must be used to determine which of the multiple possible solutions must be utilised. This usually involves the application of artificial boundary conditions to limit the degrees of freedom of the robot.

### SUMMARY OF THE INVENTION

In a first aspect, the present invention provides a method for controlling a system formed from a plurality of interdependent units to achieve an outcome, comprising the steps of establishing a desired outcome for the system, and establishing a desired action for each unit responsive to the outcome but independently of the desired action of the other units.

In a second aspect, the present invention provides a method for controlling a system formed from a plurality of interdependent units to achieve an outcome, comprising the steps of establishing a desired outcome for the system, and establishing a desired action for each unit responsive to the outcome, wherein the desired action for a said unit is established in response to the current position of at least one reference portion of the system relative to a desired position of that reference portion.

The desired action for a said unit may involve calculating a difference value between the current position of a said reference portion and the desired position of that reference portion, and using said difference value to establish said desired action.

In other words, in at least an embodiment, each unit is provided with some information regarding a desired outcome (a “goal”) and is also provided with a reference position. Each unit then seeks to calculate a value which is indicative of the desired action the unit must take if it is to reach its goal. This may, in some embodiments, be a difference value between a reference position and a desired position.

The method may include the further steps of establishing an operation action for each unit; and instructing each unit to initiate its operation action.

The method may comprise the further step of iterating the method steps to update the operation action, and the rate may either be constant throughout the system, or may vary between units of the system.

The operation action for at least some of the units may be the desired action. In most cases, the desired action will be the best action for the unit to take in assisting the unit to work towards the desired outcome. However, individual links may come across constraints, such as obstacles, or the breakdown of other links.

In such a case, the method may include the further steps of establishing constraint factors for the system, and establishing a constrained action for at least one unit responsive to the constraint factors. The constrained action may override the desired action, or the constrained action and the desired action may be compared and a compromise sought.

That is, the operation action for a unit for which a constrained action has been established is the constrained action.

Once the constrained action is established, only the constraint factors for a unit may be utilised in establishing the constrained action for that unit.

However, in another form, the constraint factors relating to at least one unit may be utilised in establishing a said constrained action for another said unit.

The method may also be utilised to control more complex movements, such as the movement of a manipulator along a defined path, or the intersection of a manipulator with a moving object. In such as case, the method may include the further step of establishing a plurality of intermediate outcomes to achieve the desired outcome.

In the case where there are a plurality of intermediate outcomes, the desired actions of the units may be established in response to individual ones of the intermediate outcomes.

The method steps may be iterated so that a plurality of the desired actions for each unit is established over time, and whereby the desired actions may be established responsive to a plurality of the intermediate outcomes.

In addition to being utilised for complex behaviour, the method may also be utilised for complex systems. That is, in situations where the system comprises a series of subsystems, where each subsystem being comprised of at least one of the plurality of interdependent units, the method may further include the steps of establishing a said intermediate outcome for each subsystem, whereby the desired action for each unit is established responsive to the intermediate outcome of the subsystem to which it is associated.

That is, each subsystem functions like a self-contained system, with the intermediate outcome as their immediate goal, where the intermediate outcome is sympathetic with the desired outcome for the system as a whole.

It will be understood that the outcome may be dependent on a spatial relationship of the system, and moreover, the outcome may also be a predetermined spatial relationship of the system relative to a desired location.

The outcome may also time dependent.

The desired action involves adjusting the spatial position of that unit. In situations where there are no constraining factors, the outcome may be the sole determinant of the desired position.

The adjustment may be by way of movement of the unit and/or expansion or contraction of that unit.

In a third aspect, the present invention provides a method for controlling a plurality of interdependent units, comprising the steps of, for each unit, independently deriving an operation action, the operation action being responsive to starting information.

The starting information is selected from the group comprising a desired outcome, a desired action, a constraint action and a reference position.

In a fourth aspect, the present invention provides a system for controlling a plurality of interdependent units movable to achieve an outcome, the system comprising a controller arranged to implement a control methodology in accordance with a first aspect of the invention.

In a fifth aspect, the present invention provides a computer program arranged to, when loaded on a computing system, perform the method in accordance with a first aspect.

In a sixth aspect, the present invention provides a computer readable medium incorporating a computer program in accordance with a fourth aspect.

### DETAILED DESCRIPTION OF THE DRAWINGS

Further features of an embodiment of the present invention will now be described, by way of example only, with reference to the following figures in which:

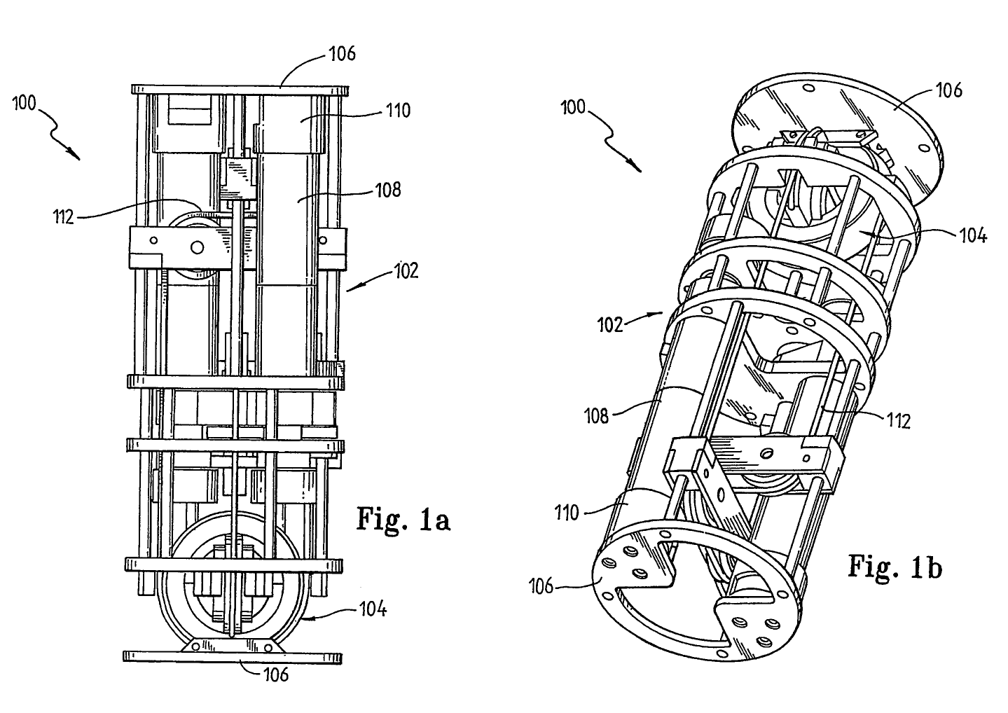

FIGS. 1a and 1b are schematic diagrams of an individual link of a manipulator in accordance with an embodiment of the present invention;

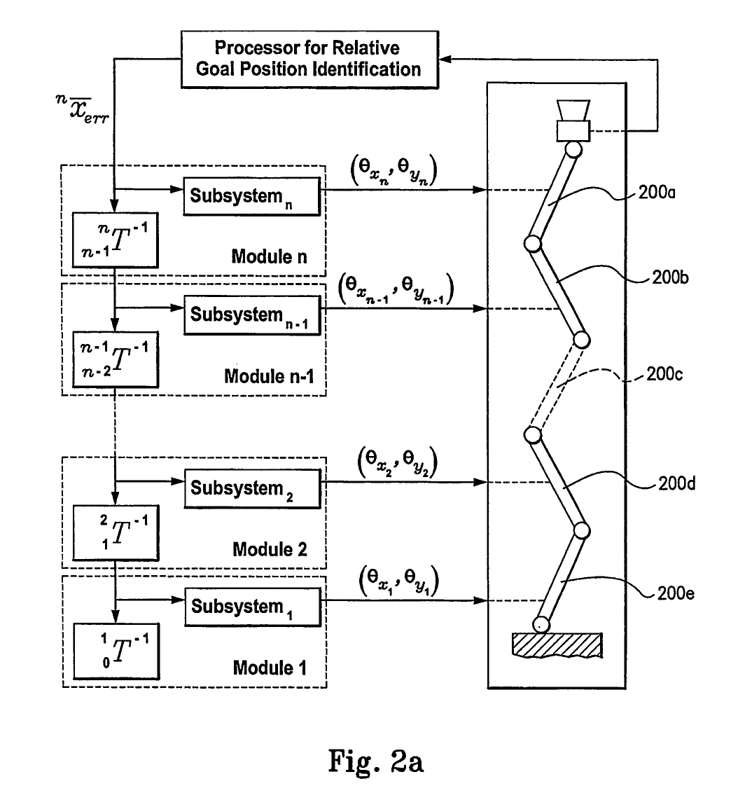

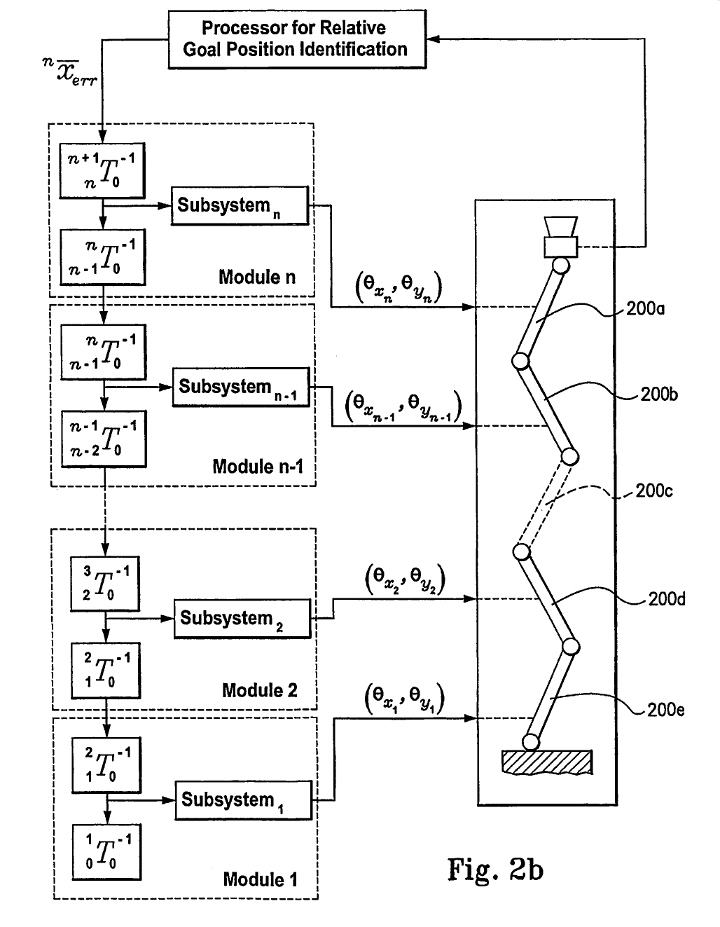

FIG. 2a is a schematic diagram illustrating a manipulator in accordance with an embodiment of the present invention and FIG. 2b is a schematic diagram illustrating a manipulator in accordance with another embodiment of the present invention;

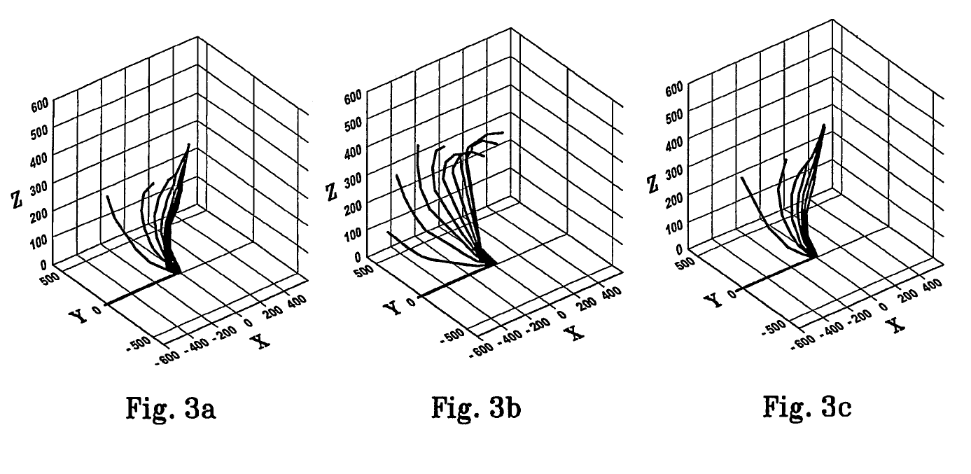

FIGS. 3a to 3c are a series of graphs that describe the simulated movement of a manipulator in accordance with an embodiment of the present invention;

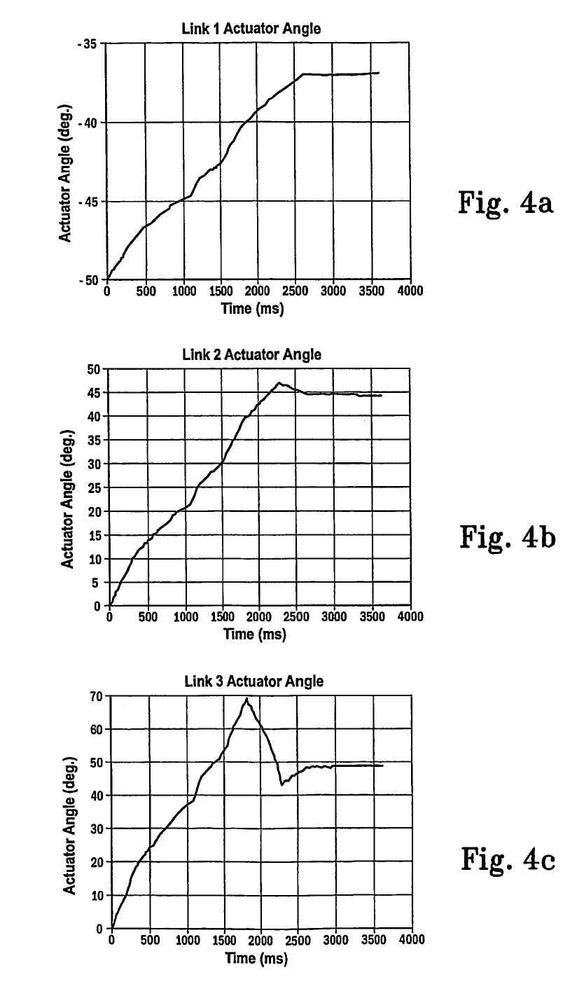

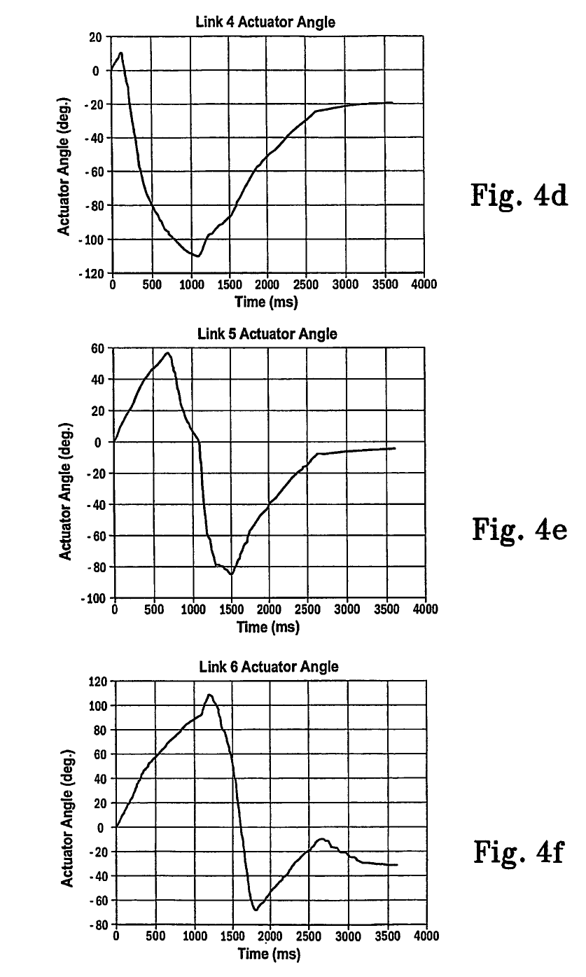

FIGS. 4a to 4f are a series of graphs that describe the actuation angle for each link, as a function of time for a manipulator in accordance with an embodiment of the present invention;

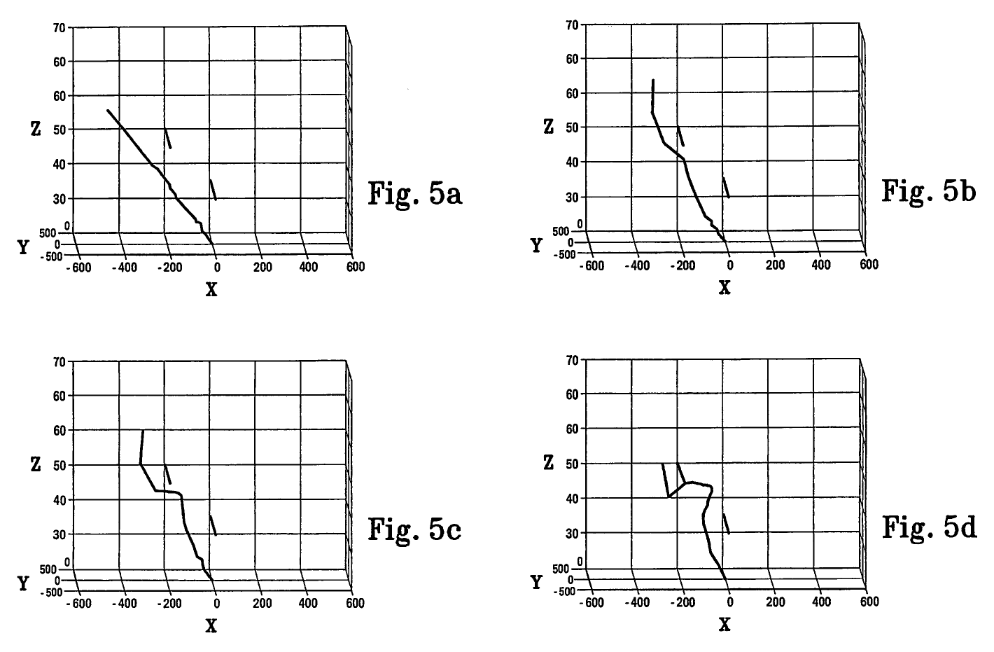

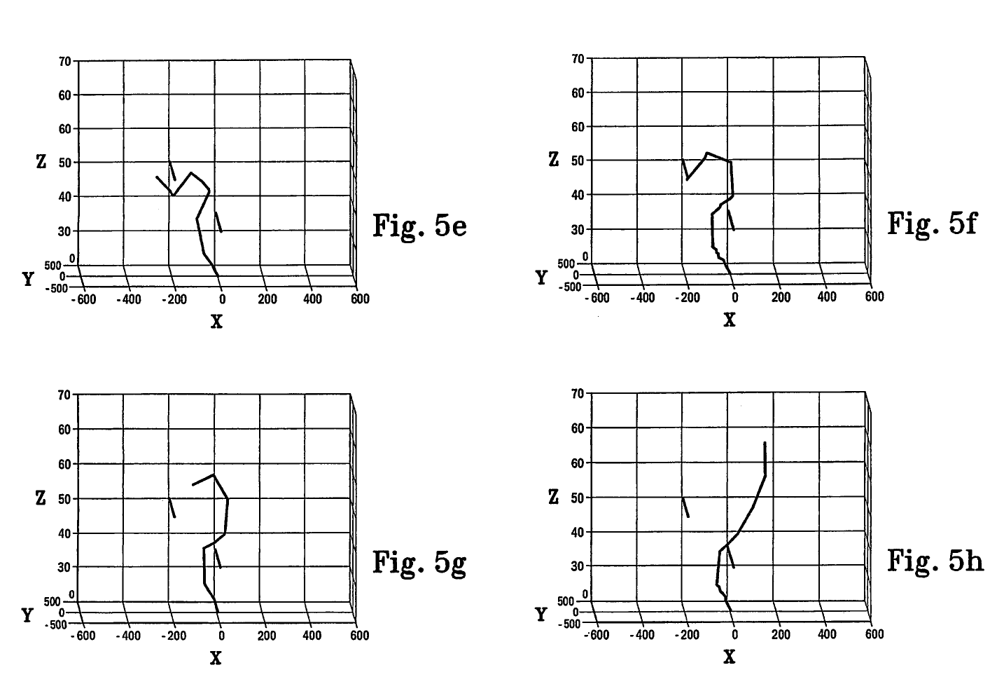

FIGS. 5a to 5h are a series of graphs depicting an obstacle avoidance sequence as a function of time, for a manipulator in accordance with the present invention;

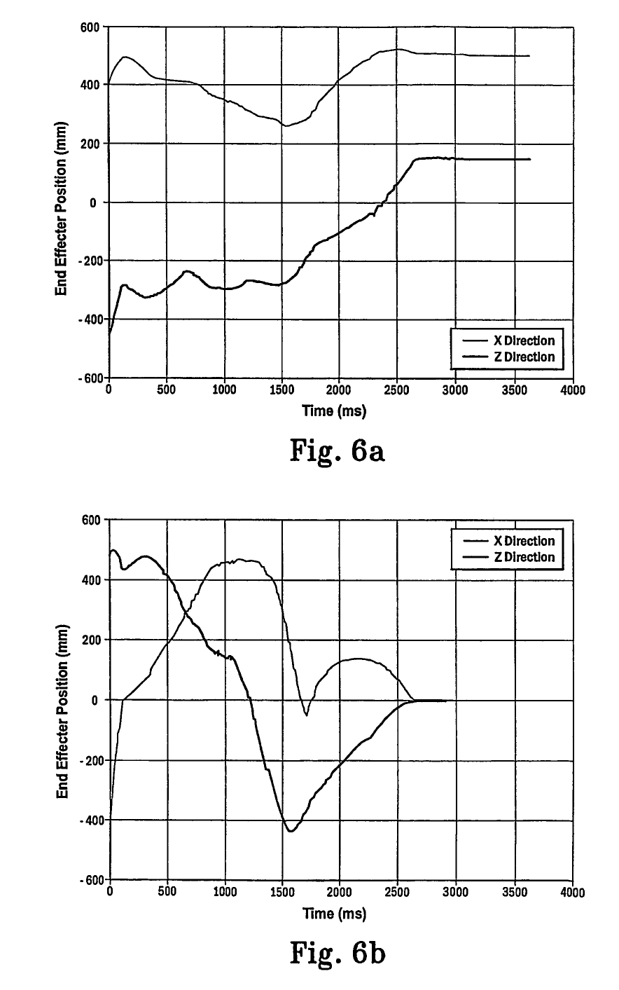

FIG. 6a is a graph depicting the reference link's position relative to the base of a manipulator in accordance with an embodiment of the present invention;

FIG. 6b is a graph depicting the error value relative to an final position for a manipulator in accordance with an embodiment of the present invention;

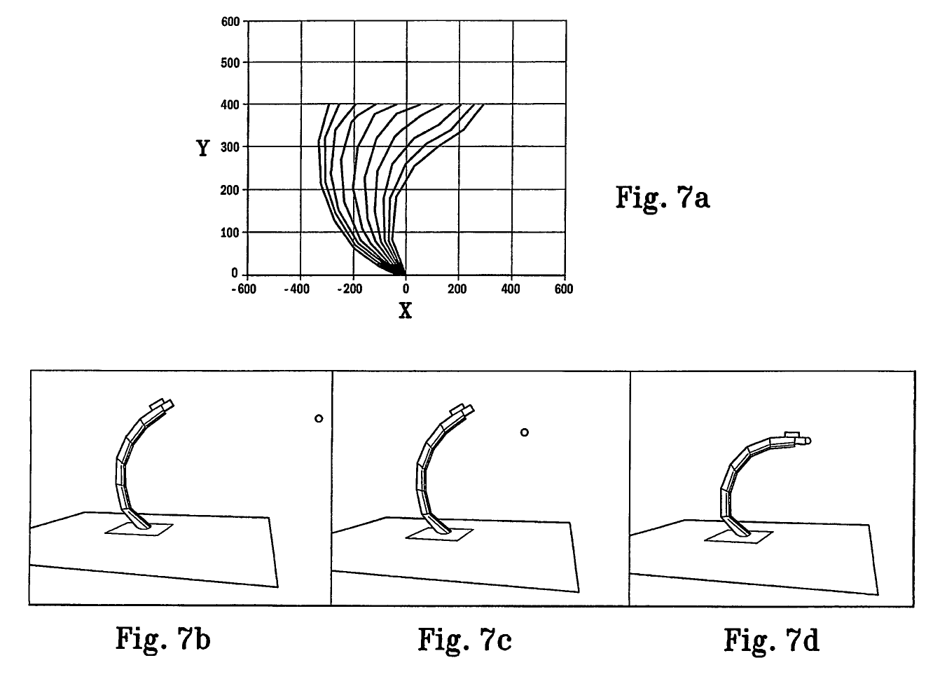

FIG. 7a is a diagram depicting the movement of a manipulator along a path, and FIGS. 7b, 7c and 7d are images of a manipulator intersecting a moving target;

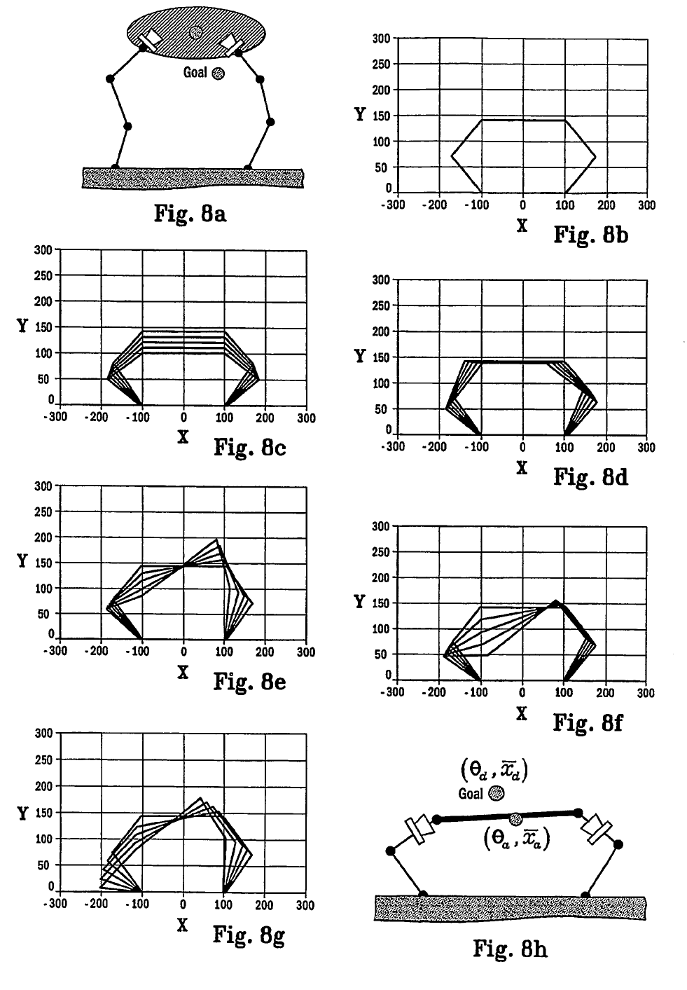

FIG. 8a is a diagram depicting the use of the methodology in accordance with an embodiment of the present invention when the parts are not physically interdependent, and FIGS. 8b-8g are graphs depicting a MATLAB simulation of the example depicted in FIG. 8a, and FIG. 8h is another diagram depicting the use of the methodology depicted in FIG. 8a;

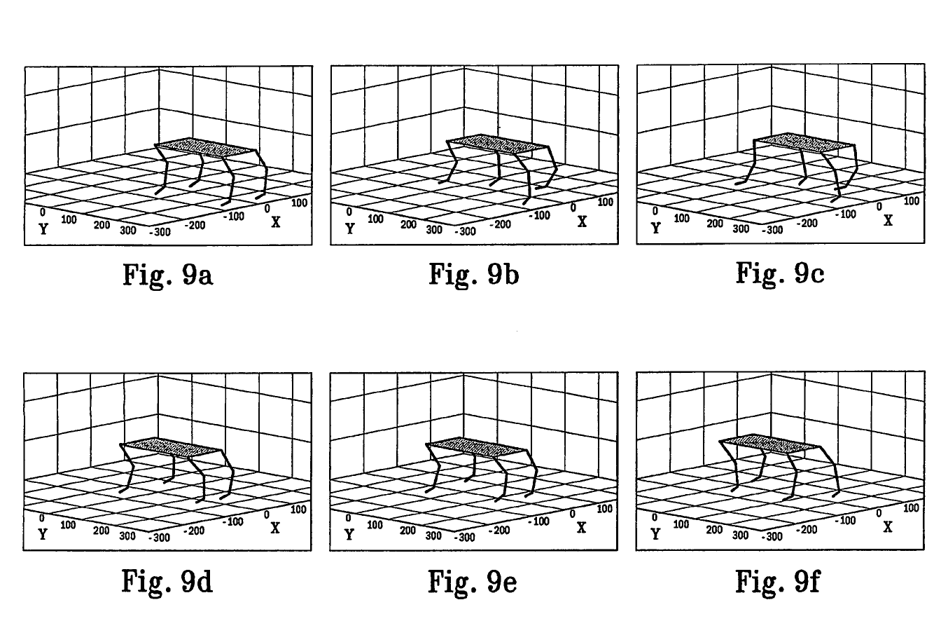

FIGS. 9a-9f are graphs of a MATLAB simulation depicting a multi-manipulator system of a “dog” walking motion, utilising a decentralised control methodology in accordance with an embodiment of the present invention;

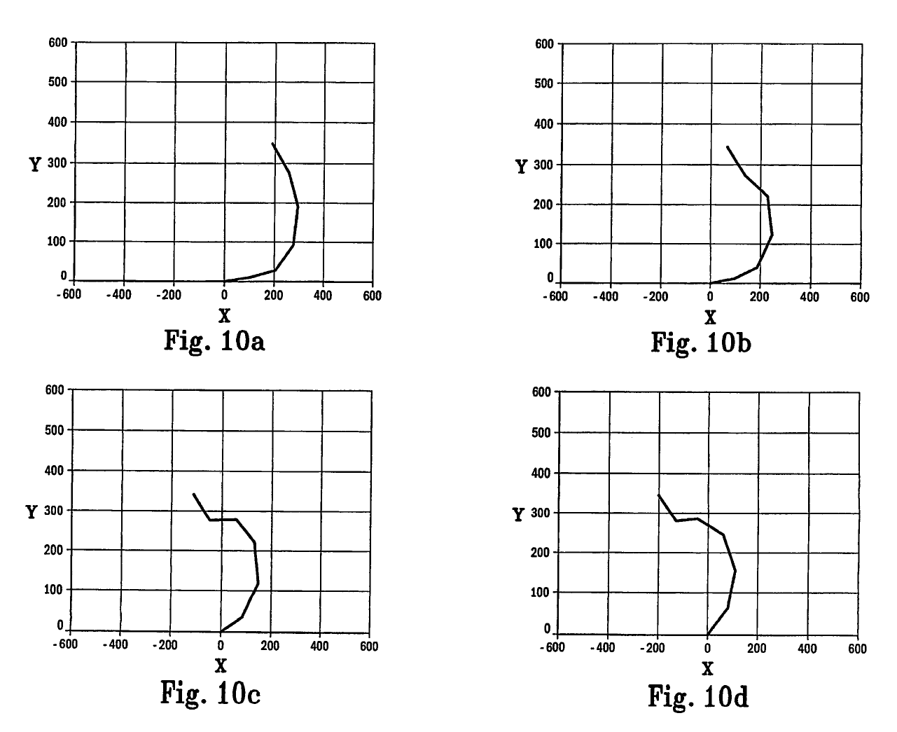

FIGS. 10a-d are graphs of a MATLAB simulation where the decentralised control methodology in accordance with an embodiment of the present invention is utilised to control the orientation of a manipulator link;

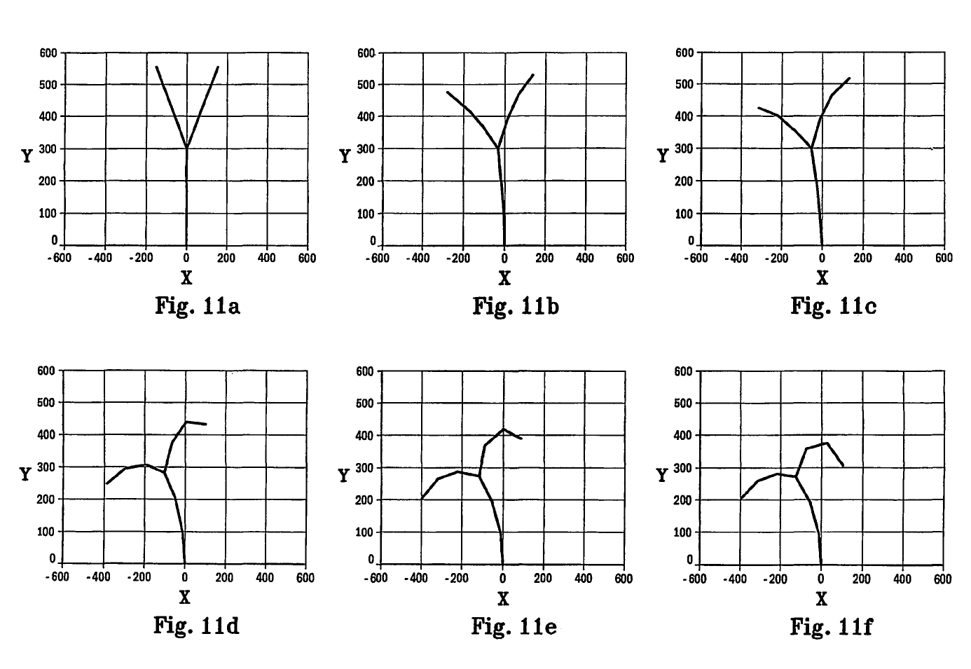

FIGS. 11a-f are graphs of a MATLAB simulation where the decentralised control methodology in accordance with an embodiment of the present invention is utilised to control a bifurcated manipulator module including two arms and a base; and

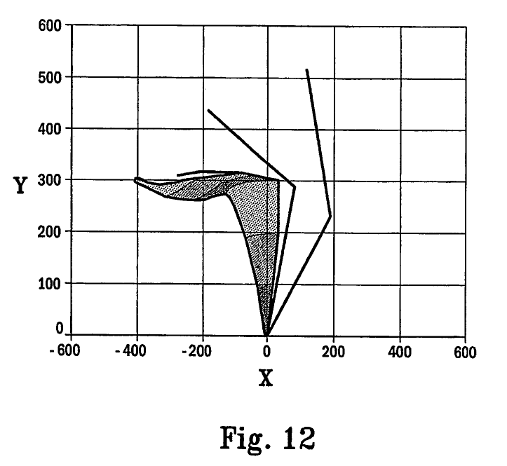

FIG. 12 is a graph of a MATLAB simulation demonstrating the switching between a centralised and a decentralised control methodology.

### DESCRIPTION OF A SPECIFIC EMBODIMENT

### General Description

A control methodology is disclosed which allows a plurality of interdependent units to work co-operatively yet independently to reach a desired outcome. This is achieved through the use of a decentralised control system and methodology, where each of the units establishes and initiates an operation action utilising starting information, that may be derived from any one or more of a desired outcome, and constraining factors. The operation action is usually a desired action that is directed to achieving the desired outcome, but may be a constraint action if constraining factors are present. Once the operation action is defined, the unit initiates that action. This process is iterated with the operation action being updated at each iteration until the desired outcome is reached. The control methodology may find application in a number of disparate fields. However, one natural application is in the control of robots and in particular robotic manipulators.

In the context of the present specification, the desired outcome is generally based on location of a reference portion at a desired fixed position in space. However, it will be understood that the desired position may change over time (i.e. during iteration of the process) by establishing a plurality of intermediate outcomes. In this way, the desired outcome may be the movement along a line or a curve.

In the context of the present specification, the term interdependent refers to constituent parts which are not necessarily physically connected, but are constrained by one another in some form such as being related spatially. An example of an interdependent system is a robotic arm, normally termed a “manipulator” in the art.

In the example utilising a manipulator, each unit in the manipulator is generally termed a manipulator module, a manipulator link or a manipulator portion.

### Example Manipulator Module

An example of a suitable manipulator module will now be described, by way of example only. Referring to FIGS. 1a and 1b, there is shown a manipulator module 100 in accordance with an embodiment of the present invention. The manipulator module 100 includes a body portion 102 which is capable of housing a joint structure 104 arranged to allow the module to provide two rotational degrees of freedom.

The manipulator module 100 further includes attachment means 106 which are substantially planar structures in the form of a plate. The plates allow the module to interconnect to another module (not shown). It will be understood that in some embodiments, modules may be integrally moulded with other modules, thereby obviating the need for attachment means.

The body 102 is also arranged to receive the actuation means 108. The actuators 108 are connected to the joint structure 104 to provide relative movement of the joint structure 104.

The actuation means 108 includes a motor 110 which drives a gear head (not shown). The gear head drives a belt drive 112 (not shown) which in turn drives a linear actuator in the form of a ball screw (not shown). The linear actuator drives a tension drive, which in the present embodiment includes a cable. The cable is connected at one end of the joint 102, and at the other end to a pulley to allow for bidirectional control of the joint.

In other words, when the motor is activated, it drives the gear head, which in turn drives the linear actuator, causing the cable drive to move, thereby moving the joint through an angle θ. It will be understood that a similar actuator means is utilised for both arc shaped portions, thereby providing motorised control for both degrees of freedom of the joint structure.

As can be seen, the manipulator module is relatively compact in size, is completely self contained (i.e. all driving parts are contained within the manipulator module), and the attachment plates allow the manipulator module to be easily connected to another module. In another embodiment, the manipulator may be integrally formed, such that the joint is integrally formed with either one or both of the elements on each side of the joint.

The manipulator module may include communication means, which may take the form of an electronic interface (i.e. an electronic bus) that interfaces the motors to a control means. The control means may be a control pad (such as a joystick) in the case of a manually controlled manipulator module, or it may be a computing means (such as a microcontroller or a computer) in the case of a programmable manipulator module. In other embodiments, the communication means and the microcontroller (or equivalent) may be wholly contained within each module, such that each module may operate independently of other modules.

The manipulator module may also incorporate appropriate sensors which may be required to sense the surrounding environment, to avoid obstacles or to provide information on some external condition, such as temperature, humidity, etc. In one particular embodiment, the sensor may be an optical encoder, which may be used to measure the proximity of obstacles. Another possible sensor could be a pressure sensor, which may be used to determine whether the manipulator module has come into contact with an external object.

### Simple Multiple-Unit Manipulator

Turning to FIGS. 2a and 2b, there is shown a schematic diagram that depicts an assembled manipulator. The manipulator is comprised of a series of interdependent units, namely links or modules 200a to 200e, each link being connected to a successive link and rotatable about two degrees of freedom, namely an arbitrary “x” and “y” plane. The manipulator is controlled by a decentralised control mechanism, which allows for independent control of each link of the plurality of interdependent units.

The manipulator has a control system that is laid out such that each link of the manipulator has a separate embedded processor which independently controls the motion of the particular link in response to the provision of particular input information, namely the desired outcome (i.e. the position to which the manipulator wants to move) and a reference position (i.e. the position of the reference link, which will be described in more detail later). The input information may also include information regarding the presence of obstacles (which is provided by the proximity sensor).

It will be understood that whilst this particular embodiment has a separate processor for each link, a central processor could be utilised, in a multi-tasking mode, to perform necessary calculations on behalf of each link. That is, while one processor performs all calculations, the calculations would be independent and unique for each link.

The manner in which information regarding the reference position is provided to each link may be varied. In the example to be described, each link is provided with information regarding the position of an adjacent link relative to a reference position (i.e. the position of the reference link). However, this is not the only manner in which such information may be passed from link to link. In another embodiment, each link may have a sensor which provides it with information regarding a reference position. In this way, each link may operate independently of other links. However, for convenience, the embodiment described herein relies on information being relayed from one link to the next, as this is a cost effective option when constructing the embodiment.

That is, whilst the physical layout of the embodiment described in FIGS. 2a and 2b is serial in nature, and therefore information distribution occurs in a serial manner, the underlying control methodology of each link is independent of the other links. The control may be achieved (i.e. information may flow from link to link) in a tree, net or parallel structure.

In FIG. 2a, the information input to each link is not manipulated and the information output from each link may be manipulated before it is passed to a successive link. However, it will be understood, that in other embodiments, such as the one disclosed in FIG. 2b, the information input to each link and the information output from each link may be manipulated in any appropriate manner. Such information manipulation may be advantageous as the partial transformation of information may preferably minimise the transfer of information from link to link. Moreover, as a corollary, by minimising the amount of information transferred between each link, the amount of data received by each link is also correspondingly decreased. This may reduce the need for a wide data bus between links and allow for faster response times.

In the present embodiment, the links are arranged in a serial structure, as the manipulator as described is particularly suitable for the collection of objects which are arranged in a random fashion (e.g. fruit located on a tree or vine). It will be understood that the methodology described herein is not restricted to serial structures, and may be utilised to control any structure of interdependent units.

The manipulator of the embodiment operates in the following manner.

A desired outcome (i.e. a desired position) is recognized by the reference link of the manipulator. The desired position may be determined by any appropriate means, such as a stereo vision module or similar device, or it may be provided by an operator or pre-programmed into the manipulator. Once the desired position, dubbed ⁿ X̅_{d} is determined, each link is provided with the desired position and programmed such that each link's prime objective is to position a reference portion (in one embodiment the end link of the manipulator) at the desired position.

Each module “i” is provided with two local input (information) values, ⁱ⁺¹ X̅ₐ, ⁱ⁺¹ X̅_{d} which represent the actual position of the adjacent link (i+1) and the desired position of the adjacent link (i+1). These are, in effect, transformed values of the original reference position and the desired position. However, it will be understood that each link could utilise the original values and apply appropriate transformations to derive a and desired action for each link in its own frame of reference.

Using the input information provided and equations 1 and 2 (below), the desired action for each link can be determined, and therefore the rotational errors in the link may also be determined in the particular link's frame of reference.

ⁱ x̅ₐ̅= f̅₂̅(ⁱ x̅ₐ̅,θₓ_{₊₁},θ_{y}_{ᵢ₊₁},lᵢ) (1)

ⁱ x̅_̅{̅d̅}̅= f̅₃̅(ⁱ x̅_̅{̅d̅}̅,θₓ_{ᵢ₊₁},θ_{y}_{ᵢ₊₁},lᵢ) (2)

Once the desired position for each link is determined, in its own frame of reference, the rotational error of each link may then be computed using equations 3 and 4 (below).

ⁱ x̅ₑᵣᵣ= f̅₄̅(ⁱ x̅ₐ,ⁱ x̅_{d}) (3)

[θₓ,θ_{y}]ₑᵣᵣ^{T}= f̅₅̅(ⁱ x̅ₑᵣᵣ) (4)

Where fⱼ refers to a specific function appropriate to the link structure and the link interconnectivity.

Once the desired action for each link is calculated, an operation action is established for each link. That is, the desired action is transformed into a command to move the link in an appropriate manner. Each actuator in each link may then be operated to move the link under this operation action. This process is iterated with the input information and operation actions updated. The process continues until the calculated rotational errors are reduced to zero, thereby indicating that the desired outcome has been reached.

Therefore, the manipulator operates by allowing each link in the manipulator to perform a desired local action, by providing each link with information pertaining to the desired outcome and a reference position, to allow each individual link to transform the information into a desired action that is compatible with and contributes towards the desired outcome. This advantageously allows each link to make local decisions independently of other links, whilst still contributing to the desired outcome. This is particularly useful where one or more of the individual links is presented with an obstacle or a series of unforseen obstacles, or if one link in the plurality of links ceases to operate. Both the presence of an obstacle and the cessation of operation of a link may be modeled as a constraint factor (i.e. an action which restricts the movement of at least one module). Once the presence of a constraint factor becomes known (for example, through the use of a sensor), the constraint factor can be taken into consideration, and a constraint action can be established both locally and universally. Alternatively, if one unit ceases to operate, this may be ignored by other units with the system not establishing a constraint factor for the failure of that unit. The other units may continue to operate as they each establish their operation action independently of the other units.

That is, when an individual link detects or becomes aware of an obstacle, the link may adjust its own path and movement to avoid the obstacle, whilst simultaneously balancing the constraint action (i.e. avoiding the obstacle), with the primary objective of moving the manipulator to its end position. Alternatively, depending on the type of constraint, the constraint action may be performed instead of the desired action. That is the desired action does not automatically translate into an operation action where constraint factors are present, the operation within may be the constraint action or it may be some combination or average of the desired action and the constraint action.

In a particular embodiment, each link may also be capable of sending a broadcast message to other links, such that they may become aware of obstacles in advance, and also assist in taking corrective action to avoid the obstacle. In other words, constraint factors relating to one unit may be utilised in establishing a constraint action for other units. This will further the collision avoidance capabilities of the manipulator.

Furthermore, if one link breaks down or becomes inoperative, successive links can adjust their constraint actions accordingly to compensate for the problematic link. In other words, the decentralised control method provides redundant manipulator control, so a fault in one or more links does not necessarily render the manipulator inactive. As a corollary, extra links may also be added to the manipulator without the need to reprogram the manipulator.

That is, at least an embodiment of the present invention allows for dynamically reconfigurable manipulators. This may be particularly useful in situations where the length of the manipulator may need to be altered at short notice (e.g. in fruit picking applications, extra links may be added to the manipulator to compensate for environmental factors such as tree growth, thicker foliage, etc.).

Advantageously, the manipulator can dynamically plan a path, which is important in applications where tasks are not repetitive.

An example of a system in accordance with an embodiment of the present invention will now be described, with reference to FIGS. 3 and 4.

A simulation, utilising the MATLAB Simulink software application, was produced to demonstrate the practicality of the manipulator control mechanism described herein. In the simulation, each link is aware of its own angular offsets, morphology and the distance from the reference position to the desired outcome position.

The links are physically connected in series, though they function independently of each other and work in parallel to achieve the desired outcome. The simulation layout is arranged for information flow in one direction from a defined reference link through to the base link in the manipulator.

The link properties include two degrees of freedom per link, which allows each link to move on the surface of a sphere. Communication between successive links and embedded processors on individual links takes place in the same manner as the manipulator shown in FIGS. 2a and 2b.

The manipulator utilised in the simulation is comprised of six 100 unit long links (“unit” being any arbitrary measure of length). In the simulation, a desired outcome (i.e. the desired final position of the reference portion link) is kept constant relative to the base position.

Two examples where the manipulator's structure is altered and then controlled to achieve a desired outcome position will now be described. It is to be noted that after reconfiguration of links, no re-programming of the system is required.

FIG. 3a shows the normal successful motion of a regular manipulator instructed to move from the initial condition (−600,0,0) to the final position, set at (300,300,350).

The first simulation demonstrates the dynamic abilities of the manipulator when a link is modified. The third link from the base, which was originally 100 units long, is replaced with a link of a different length, now 300 units long. By keeping all other parameters constant and without informing other links of the change, the manipulator is instructed to reach the goal end position (300,300,350). FIG. 3b shows the resulting motion profile of the manipulator. As can be seen in the figure, the manipulator is able to successfully reach the same final position.

The second simulation simulates the failure of one link during motion. The manipulator attempts to reach a given final position, but at some point during the simulator, one link's capability is lost. FIG. 3c shows the ability of the manipulator to circumvent the fault when moving towards a final position. In the example, the link closest to the reference link was caused to fail some time into the goal-seeking routine. FIG. 3c shows the resulting motion profile of the manipulator in again successfully reaching the set goal position.

In the plots shown in FIGS. 3a to 3c, no optimisation of the manipulator's motion profiles have been used through the use of varying time constants in each links.

Another advantage of using a redundant manipulator in reaching an final position is the ability of the manipulator to avoid obstacles. Referring to FIG. 4, there is shown a six link 12 degree of freedom manipulator approaching a final position (150,0,500) while avoiding two obstacles. The initial condition of the manipulator places the reference link at (−450,0,386) as shown in FIG. 4a. The obstacles used are two bars with coordinates (−200,−300≦y≦300,300) and (0,−300≦y≦300,150).

To avoid obstacles, each link's proximity sensor is activated when an obstacle encroaches into a hypothetical cylindrical shell of radius 50 units centered on the axis of each link. The link may provide an actuator motion (a constraint action) so as to repel itself from the obstacle in the shortest possible path (i.e. by moving away from the obstacle). The function used for obstacle avoidance in the simulation is where q=1 when the proximity sensor is idle and q=0 when the proximity sensor is activated.

[θₓ_{ᵢ},θ_{y}_{ᵢ}]_{errnew}^{T}=2·(q−0.5)·[θₓ_{ᵢ},θ_{y}_{ᵢ}]ₑᵣᵣ^{T} (5)

In the simulation, heuristic optimisation of the manipulator's motion is achieved by modifying the time constants of the first order response of each link (i.e. the speed of response). The shortest time constant (or the “fastest” speed of response) is given to the link nearest to the reference link, incrementally increasing by a factor of 2 for each successive link.

FIG. 3 shows the reconfigurable capabilities of the decentralised control approach where the manipulator design can be altered through the introduction of links with irregular properties depending on application requirements. The links contain self-reliant data, acting as plug-and-play components in the manipulator. The redundant nature of the manipulator further allows for fault tolerance as shown in FIG. 3c. If link failure occurs, the remaining links individually accommodate changes, dynamically providing a means for reaching the goal. The manipulator's paths intuitively appear close to optimal for each scenario, dynamically adjusting to accommodate for system changes.

FIG. 4 shows the motion profile of the manipulator successfully negotiating the two obstacles and reaching the set goal. As can be seen in FIG. 4a, the manipulator is initially presented with an obstacle, and as can be seen in FIGS. 4b through 4g, each link in the manipulator adjusts its position relative to the two obstacles to successfully negotiate the obstacles, until the final desired position is reached (FIG. 4h).

The obstacle avoidance scenario in FIG. 4 shows how the manipulator negotiates obstacles, successfully reaching the final position. It is noted that the decentralised control algorithm allows for the reference link to temporarily move away from the final position when negotiating obstacles.

The serial layout of the manipulator further provides a means of determining motion around obstacles. Where the obstacle is near the base of the manipulator, the links attempt to reach the final position by orientating around the obstacle. However if the obstacle is a significant distance from the base of the manipulator, the links will drive the manipulator past the obstacle, retracting the reference link rather than wrapping around the obstacle.

Experimentation with the manipulator time constant revealed that it was advantageous for the links nearest to the reference link to be more responsive then those further away from the reference link. This enabled the reference link to be in transit to the final position before links away from the reference link had the opportunity to take affect, in order to favour line of sight movement of the reference link relative to the final position.

The independent motion of each link can be seen in FIG. 5 with desired motions being hindered where links avoid an obstacle. The sequential avoidance of the obstacle at (−200,−300≦y≦300,300) by links 4, 5 and 6 are manifested by non-monotonic actuator velocities in respective motion profiles. These procedures are coupled, e.g. link 4 and link 5 avoid the obstacle simultaneously.

Similarly, avoidance of the obstacle at (0,−300≦y≦300,150) by links 2 and 3 also involves non-monotonic actuator velocities.

FIG. 6 shows the position of the reference link relative to the base and relative to the final position. Though some individual actuator motion characteristics are evident, the elicitation of the required individual link motions is not evident. The reference link error in FIG. 6b, which is used to drive the links, shows distinct non-monotonic behaviour, which normally only occurs with complex centrally controlled systems. This is achieved simply by decentralising the motion control.

The changes in motor directions as observed in FIG. 5 might appear at first undesirable e.g. link 6 angles return close to their original values. When viewing the overall motion in FIG. 4 such behaviour is desirable in finding a smooth path around the obstacles to the final position.

Therefore, at least an embodiment of the present invention provides a system and method for controlling a reconfigurable redundant manipulator.

The system and method readily accommodate for system reconfigurability, dynamically adjusting motion and utilising the flexibility of the complete manipulator. The capabilities of the decentralised control method include, redundant control, reconfigurable modular designs, fault tolerant motion control, dynamic path planning, and real-time obstacle avoidance capabilities.

It will be understood that whilst the embodiment described herein makes reference to a manipulator and the movement of the manipulator to a defined point in space, the decentralised control methodology may be applied to any system which incorporates a plurality of interdependent units.

Motion Along a Defined Path, and/or Intersection with a Moving Object

For example, the desired outcome need not be limited to a movement towards a fixed point in space. The point in space can change over time, allowing for motion along a defined path or for the manipulator to intersect the path of a moving target. In other words, the outcome may have a time dependence component.

The control methodology remains unchanged as calculations within each module can be iterative, so at each iteration, the desired outcome can be modified so that the manipulator is constantly moving towards the desired outcome. This effectively creates a movement akin to the arm moving along a defined path or tracking a moving object. An example of the motion described above is given in FIGS. 7a-7d. As can be seen, particularly in FIG. 7a, the manipulator can be programmed to move along a defined path by merely changing the desired outcome as the arm approaches the desired outcome. In FIG. 7a, the manipulator follows a path defined by the equation (x,y)=(−300+mt, 400) for mt in the set (0,600).

In more detail, the desired outcome as observed by the individual i^{th} module is a point ⁱ x̅_{g}. This point need not be limited to a fixed point in space. The point can be time dependant, allowing for the critical point ^{b} x̅ₑ to follow a trajectory of a time dependant desired outcome. This can be achieved by redefining the desired outcome, as observed by the end module ⁿ x̅_{g}, prior to passing this information through to the subsequent modules. This is outlined in equation (6) below.

ⁿ x̅_{g}(t)=f_{goal}(ⁿ x̅_{g}(t−1),t) (6)

The control methodology remains unchanged as calculations within each module utilizing the outcome are iterative. An additional capability which may be incorporated into the time dependant motion of the manipulator is the approximate motion of the manipulator through various waypoints. This introduces an additional parameter by which the desired outcome as observed by the end module ⁿ x̅_{g} is defined (see equation 7).

ⁿ x̅_{g}(t)=f_{goal}(ⁿ x̅_{g}(t−1),t,r₁(t−1)) (7)

The additional parameter r₁ introduces the capability of the manipulator to vary the outcome when for example the outcome is within a given range from the critical point as defined by equation 8.

r₁(t−1)=\sqrt{ⁿx(t−1)_{g}²+ⁿy(t−1)_{g}²+ⁿz(t−1)_{g}²} (8)

In the below example the critical point ^{b} x̅ₑ follows a trajectory of a time dependant goal defined by equation 9 for t ∈ 0,100; ⁿx_{g}(0)=−300; ⁿy_{g}(0)=400

ⁿx_{g}(t)=ⁿx_{g}(t−1)+6t

ⁿy_{g}(t)=ⁿy_{g}(t−1) (9)

A further capability which may be incorporated into the motion of the manipulator is through intersecting the path of a moving object. This redefines the parameter r₁ by which the desired outcome, as observed by the end module ⁿ x̅_{g}, is defined (see equation 10).

ⁿ x̅_{g}(t)=f_{goal}(ⁿ x̅_{g}(t−1),t,q)·r₂(t−1) (10)

The parameter r₂ introduces the capability of the manipulator to enable the outcome when for example the outcome is within a given range q from the critical point as defined by equation 11.

$${r}_{2} ( t - 1 ) = \{ \frac{\sqrt{{ }^{n} {x ( t - 1 )}_{g}^{2} {+}^{n} {y ( t - 1 )}_{g}^{2} {+}^{n} {z ( t - 1 )}_{g}^{2}} \leq q = 1}{\sqrt{{ }^{n} {x ( t - 1 )}_{g}^{2} {+}^{n} {y ( t - 1 )}_{g}^{2} {+}^{n} {z ( t - 1 )}_{g}^{2}} > q = 0} \} \qquad ( 11 )$$

In the below example the manipulator is demonstrated catching a ball where the ball is the desired outcome, for the range q=200.

### Centering a Platform Based on the Centre of Mass (Stewart Platform)

Moreover, the relationship between the units need not be limited to the physical connection between modules in a manipulator. At FIG. 8a, there is shown a diagram depicting a situation where two robotic manipulators interact to place the centre of mass of a non-rigid object at given point in space. Each robotic manipulator may be considered to be a subsystem of the system (i.e. the Stewart platform). The control methodology remains unchanged though the desired outcome is now characterized by the object's centre of mass, where the camera now observes the object's centre of mass position and goal position, passing it as previously from module to module. A simulation of the permutations of such a device is shown in FIGS. 8b-g.

The critical point for the interacting two link manipulators in the above example is the centre of the beam, which is:

$$( {θ}_{a} , {\overline{x}}_{a} ) \qquad ( 12 )$$

This point is orientated by each of the manipulators such that the critical point moves towards the desired point and orientation:

$$( {θ}_{d} , {\overline{x}}_{d} ) \qquad ( 13 )$$

as shown in FIG. 8h. Each subsystem (i.e. each manipulator arm) continues to have a desired outcome, namely the centering of the mass, but each manipulator arm now has an intermediate outcome, in that each manipulator arm is acting independently of the other manipulator arm.

### Complex Multi-Limb Systems

Of course, the methodology could also be expanded to more complex motion, such as the mimicking of the walking of a dog. The diagonally alternate leg pairs are used to maintain the orientation of the body while propelling it forward in a manner similar to all previous examples.

Simultaneously, the other diagonally alternate leg pair use their respective body connections as bases to lift the feet (shortest link length) and move them forward. These motions are then switched repeatedly resulting in a walking motion, as shown in FIGS. 9a-f.

In the dog walking example, the control methodology is utilised to control the motion of each leg relative to each other leg, and also each section of a leg in relation to other sections of the leg. That is, the “units” may be defined as one leg in relation to another leg, and separately, each link in a leg in relation to the other links. Therefore, the control methodology is being utilised in two different ways, to perform two different tasks. Both tasks occur simultaneously and do not interfere with each other. In other words, once again, the desired outcome is for the dog to walk. This is broken down into a number of intermediate outcomes, namely the motion of each leg relative to each other leg. By utilising a series of “nested” outcomes, one for each structure (namely the movement of each link in a leg, and the movement of each leg as a whole relative to each other leg) very complex desired outcomes can be achieved.

### Bifurcated (and Other Multiple-Arm) Systems

Another example of a complex structure where the methodology may be applied is a bifurcated (or n-tuple) manipulator with a common base.

In the example shown in FIGS. 11a-f, there is provided three connected manipulators each composed of three links and assembled into a Y formation. The bifurcated manipulator may be seen as the “system”, with each of the three manipulators forming a subsystem.

The desired outcome may be to place each of the two manipulator arms in a desired position. This can be broken down into the two end effectors having different intermediate outcomes. In the example, the left end effector wishes to move to the point (−400,200) and the right end effector wishes to move to the point (100,300).

The individual upper sections use the unchanged control methodology to reach for their respective goals, ⁿ x̅_{g}_{¹} and ^{m} x̅_{g}_{²}.

The base section, comprising three links, also has an intermediate outcome sympathetic with the desired outcome of moving each of the two end effectors to their respective locations. The base section uses combined information sourced from both of the top sections in determining the 3^{rd} link's intermediate outcome. In other words, by taking an “average” of the intermediate outcome for each individual manipulator arm, the base section devises its own intermediate outcome which allows both manipulator arms to reach their intermediate outcome, and in turn, achieves the desired outcome for the system as a whole (assuming there is sufficient length as shown in equations 14 and 15).

$$\begin{matrix}{}_{}^{i}{\overline{x}}{}_{g}^{} = \frac{{}_{}^{i + 1}{\overline{x}}{}_{g 1}^{} + {}_{}^{i + 1}{\overline{x}}{}_{g 2}^{}}{2} & ( 14 ) \\ {}_{}^{i}{\overline{x}}{}_{e}^{} = \frac{{}_{}^{i + 1}{\overline{x}}{}_{e 1}^{} + {}_{}^{i + 1}{\overline{x}}{}_{e 2}^{}}{2} & ( 15 )\end{matrix}$$

The first and second links in the base section receive ⁱ⁺¹ x̅_{g} and ⁱ⁺¹ x̅ₑ from their respective modules as required using the control methodology described for the simple manipulator example. As shown in FIG. 11a-f, the Y formation successfully reaches the intermediate outcome for each manipulator arm, thereby achieving the desired outcome. The base section orientates itself so as to aid the speed of motion in reaching the desired outcome.

### Other Types of Motion

It will also be understood that the same methodology may be applied to other types of motion, such as rotational motion. The simulation depicted in FIGS. 12a-d demonstrate orientation control of the end effector (i.e. where the end effector can rotate). This is achieved by assigning the task of orientation control to the end link of the manipulator, using equation 16 for a planar manipulator:

$${\sum }_{i = 1}^{n} {θ}_{i} = {θ}_{d} \qquad ( 16 )$$

where,

$${\dot{θ}}_{n} = f ( {\sum }_{i = 1}^{n} {θ}_{i} , {θ}_{d} ) \qquad ( 17 )$$

Whilst embodiments of the present invention refer to the use of a decentralised control methodology, it will be understood that the decentralised control methodology may be utilised in conjunction with traditional centralised control methodologies. In some situations it may not be appropriate to utilise only a decentralised control methodology. For example, in the case where a manipulator is utilised for global systemic mapping of an environment while searching for a goal, a mixed strategy is useful.

That is, the use of a centralised control methodology is more appropriate while the manipulator is mapping (i.e. scanning in a systematic manner across an area with defined boundaries). However, once the manipulator receives information regarding a desired outcome (i.e. it detects a target and is instructed to move towards the target), decentralized control is more appropriate.

The mixture of decentralised and centralised control is shown in FIG. 12, which depicts a simulation where the manipulator links are initially locked to provide only two degrees of freedom (thereby making the system non-redundant), and also allowing the system to easily perform simple movements in a defined area. Once a more specific desired outcome is required, the manipulator is switched to decentralised control, unlocking the links and introducing redundancy (six degrees of freedom), thereby increasing flexibility.

In one embodiment, information concerning each links angle is passed to a CPU. To control the two degrees of freedom system centrally the two fixed links are given by equations 18 and 19:

l₁=\sqrt{¹x₄²+¹y₄²} (18)

where ¹ x̅₄ is the base of the 4^{th} link in the base of 1^{st} link's frame of reference; and

l₂=\sqrt{⁴xₑ²+⁴yₑ²} (19)

where ⁴ x̅ₑ is the position of the end effector in the base of 4^{th} link's frame of reference.

The variables θ₂,θ₃,θ₅,θ₆ are fixed for the centralized control mode. With the 2 variables θ₁,θ₄ controlled by equation 20:

$$[ \begin{matrix}{\dot{θ}}_{1} \\ {\dot{θ}}_{4} \\ 1\end{matrix} ] = {\underline{J}}^{- 1} \cdot [ \begin{matrix}{\dot{x}}_{e} \\ {\dot{y}}_{e} \\ 1\end{matrix} ] \qquad ( 20 )$$

In example given, the initial motion is centralized with only two degrees of freedom, making the manipulator a non-redundant system. During the motion there may be a requirement to free the actuators, thereby introducing redundancy (six degrees of freedom) and flexibility into the manipulator's motion.

When redundancy is introduced, a decentralised control methodology in accordance with the embodiment is more appropriate, since it ameliorates the issues associated with redundant systems.

It will be understood that the manipulators and robots described are not constrained to any particular scale. The methodology is equally applicable to large industrial manipulators and robots, as to small robots for specialised applications. For example, the methodology could be utilised in a robot which picks fruit, or a robot which locates and removes debris from a field or a factory floor. Equally, the methodology could be applied to an intelligent surgical instrument which could self-propel through the body of a patient to a predetermined location.

The methodology is particularly suitable for delicate work, as it has many qualities which make it suitable for such work.

These include the ability to navigate unfamiliar paths, the ability to avoid obstacles, the ability to continue to operate even if a portion of the manipulator breaks down, and the ability for the manipulator to be reconfigured for different applications without needing to make any modifications to the methodology.

Modifications and variations as would be apparent to a skilled addressee are deemed to be within the scope of the present invention.

1. A method for controlling a system formed from a plurality of interdependent units to achieve an outcome, comprising the steps of establishing a desired outcome for the system, and establishing a desired action for each unit responsive to the outcome but independently of the desired action of the other units.

2. A method in accordance with claim 1, wherein the desired action for a said unit is established in response to the current position of at least one reference portion of the system relative to a desired position of that reference portion.

3. A method for controlling a system formed from a plurality of interdependent units to achieve an outcome, comprising the steps of establishing a desired outcome for the system, and establishing a desired action for each unit responsive to the outcome, wherein the desired action for a said unit is established in response to the current position of at least one reference portion of the system relative to a desired position of that reference portion.

4. A method in accordance with claim 2, wherein the desired action for a said unit involves calculating a difference value between the current position of a said reference portion and the desired position of that reference portion, and using said difference value to establish said desired action.

5. A method in accordance with claim 4, further comprising the steps of establishing an operation action for each unit; and instructing each unit to initiate its operation action.

6. A method in accordance with claim 5, further comprising the step of iterating the method steps to update the operation action.

7. A method in accordance with claim 6, wherein the rate of iteration is constant throughout the system.

8. A method in accordance with claim 6, wherein the rate of iteration varies between units of the system.

9. A method in accordance with claim 5, wherein the operation action for at least some of the units is the desired action.

10. A method in accordance with claim 5, further comprising the steps of establishing constraint factors for the system, and establishing a constrained action for at least one unit responsive to the constraint factors.

11. A method according to claim 10, wherein the operation action for a unit for which a constrained action has been established is the constrained action.

12. A method in accordance with claim 10, wherein only the constraint factors for a unit are utilised in establishing the constrained action for that unit.

13. A method in accordance with claim 10, wherein constraint factors relating to at least one unit are utilised in establishing a said constrained action for another said unit.

14. A method in accordance with further comprising the step establishing a plurality of intermediate outcomes to achieve the desired outcome.

15. A method in accordance with claim 14, wherein the desired actions of the units are established in response to individual ones of the intermediate outcomes.

16. A method in accordance with claim 14, wherein the system comprises a series of subsystems, each subsystem being comprised of at least one of the plurality of interdependent units, and the method further comprises the steps of establishing a said intermediate outcome for each subsystem, whereby the desired action for each unit is established responsive to the intermediate outcome of the subsystem to which it is associated.

17. A method in accordance with claim 14, wherein the method steps are iterative so that a plurality of the desired actions for each unit is established over time, and whereby the desired actions are established responsive to a plurality of the intermediate outcomes.

18. A method in accordance with claim 1, wherein the outcome is dependent on a spatial relationship of the system.

19. A method in accordance with claim 18, wherein the outcome is a predetermined spatial relationship of the system relative to a desired location.

20. A method in accordance with claim 18, wherein the outcome is also time dependent.

21. A method in accordance with claim 18, wherein the desired action involves adjusting the spatial position of that unit.

22. A method in accordance with claim 21, wherein the adjustment is by way of movement of the unit and/or expansion or contraction of that unit.

23. A method in accordance with claim 18, wherein the outcome determines the desired position.

24. A method for controlling a plurality of interdependent units, comprising the steps of, for each unit, independently deriving an operation action, the operation action being responsive to starting information.

25. A method in accordance with claim 24, wherein the starting information is selected from the group comprising a desired outcome, a desired action, a constraint action and a reference position.

26. A system for controlling a plurality of interdependent units movable to achieve an outcome, the system comprising a controller arranged to implement a control methodology in accordance with claim 1.

27. A system in accordance with claim 24, wherein the information regarding the presence of constraining factors is collected by a sensor.

28. A system in accordance with claim 25, wherein the movement is performed by an actuating means.

29. A system in accordance with claim 24, wherein each interdependent unit is a constituent part of a robot.

30. A system in accordance with claim 27, wherein each constituent part is a module in a robotic manipulator.

31. A system in accordance with claim 24, further comprising control means capable of switching the control methodology of the system to a centralised control methodology.

32. A computer program arranged to, when loaded on a computing system, perform the method of claim 1.

33. A computer readable medium incorporating a computer program in accordance with claim 32.

34. A computer program arranged to, when loaded on a computing system, perform the method of claim 3.

35. A computer readable medium incorporating a computer program in accordance with claim 34.

36. A system comprising a plurality of units, the units being interdependent and being capable of movement relative to one another, at least one actuator operative to move the units, and a control system operative to impart instructions to the at least one actuator to move the units, wherein the controller uses a control methodology in accordance claim 1.

37. A system in accordance with claim 36, wherein the units are interdependent by being in a predetermined spatial relationship.

38. A system in accordance with claim 37, wherein the units are interconnected.

39. A system in accordance with claim 36, wherein the control system comprises a plurality of controllers located in respective ones of the units, each controller being operative to impart instructions to the at least one actuator to move the unit to which it is associated, wherein the controllers use a control methodology in accordance with claim 1.

40. A system in accordance with claim 36, wherein each unit is a constituent part of a robot.

41. A system in accordance with claim 40, wherein each constituent part is a module in a robotic manipulator.

42. A system comprising a plurality of subsystems, each subsystem comprising a plurality of units, the units being interdependent and being capable of movement relative to one another; at least one actuator operative to move the units in each subsystem; and a control system operative to impart instructions to the at least one actuator using a control methodology in accordance with claim 1.

43. A system according to claim 42, wherein to achieve a desired outcome, intermediate outcomes are established for each of the subsystems, and wherein the control system coordinates movement of the subsystems by coordinating the intermediate outcomes for each subsystem.

44. A method in accordance with claim 3, wherein the desired action for a said unit involves calculating a difference value between the current position of a said reference portion and the desired position of that reference portion, and using said difference value to establish said desired action.
